(19) United States
(12) Patent Application Publication
(10) Pub. No.: US 2018/0031763 A1
(43) Pub. Date: Feb. 1, 2018

(54) MULTI-TIERED PHOTONIC STRUCTURES

(71) Applicant: Sutherland Cook Ellwood, JR., Cheltenham (GB)

(72) Inventor: Sutherland Cook Ellwood, JR., Cheltenham (GB)

(21) Appl. No.: 15/457,980

(22) Filed: Mar. 13, 2017

Related U.S. Application Data
(60) Provisional application No. 62/308,687, filed on Mar. 15, 2016.

(51) Int. Cl. G02B 6/12; G02B 6/122; G02B 6/124

(52) U.S. Cl. CPC G02B 6/12002; G02B 6/124; G02B 6/1225

(57) ABSTRACT

A system and method for improving VLSI of photonic components such as by improved volumetric packing density that preserves and/or enhances photonic operations and functions. Optical vias are distributed throughout a multi-tiered photonic device. These optical vias are optically communicated with different types of path optics to allow photonic information to be accessed, processed, and transmitted by photonic processing elements distributed on the various tiers.

### CROSS REFERENCE TO RELATED APPLICATIONS

This application claims benefit of U.S. Patent Application No. 62/308,687 filed 15 Mar. 2016, and this application is related to U.S. patent application Ser. No. 12/371,461 filed 13 Feb. 2009 and related to U.S. Patent Application No. 62/308,585 filed 15 Mar. 2016, the contents of which are all hereby expressly incorporated by reference thereto in their entireties for all purposes.

### FIELD OF THE INVENTION

The present invention relates generally to device volumetric structure efficiency, and more specifically, but not exclusively, to improving operational density of photonic devices, structures, integrations, and assemblies. The present invention further relates generally to signal and data processing devices, including the general domain of “computer chips,” telecom signal process devices, sensor devices, and display devices and all other data/signal processing devices, and more specifically, but not exclusively, to three-dimensional (3D) or multilayer devices in which data processing and computing and signal processing and transmission, alteration, manipulation, and modification is handled on more than one planar level of the device and in which such data may be passed between those layers as well as input and output from the device itself to some other device, connection, network, or system.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In the field of photonic integrated circuits, there is a problem in achieving VLSI integration on the scale of semiconductor electronics, in that packing large numbers of photonic elements on a given area of wafer is limited by the larger dimensions of those individual elements (on average, as compared to the dimensions of semiconductor electronic logic elements) and the area required for optical structures (waveguides and passive junctions) connecting those elements, especially in implementing anything other than simple, repetitive arrays of identical devices.

However, 3D integration of multiple lower-density photonic wafers offers another pathway to realize VLSI, and in principle provides photonics with an advantage over pure electronics for 3D VLSI. Optical signals passed between layers is done without resistance or fabrication complexity compared of electronic interconnect, in that conductive vias must be employed as a 3D electronic semiconductor structure is built up or assembled by monolithic integration, whereas optical coupling between layers may be essentially free-space or low-loss passive optics, not requiring deposition of solid material vias between layers.

But to implement a 3D integration scheme in which optical coupling is the primary interconnect between layers (other than the edges of a device) requires out-coupling of signal that is processed in-plane by modulators and devices in PIC architectures, and there does not now exist a system for efficiently and systematically moving signal from in-plane to out-of-plane.

Similarly, there is a current limitation in the opto-electronic modulation technologies available for employment in spatial light modulators, in that the best-performing modulators in photonics generally are planar modulators, where the modulation structure and surface lies roughly perpendicular to the plane of the device, to couple light that is transmitted parallel to the plane, without an efficient method or system to couple signal from these modulators out of the plane. Best-in-breed planar modulators include IBM's small-footprint Mach-Zehnder modulator, ring-resonator modulators, and planar magneto-optic and magneto-photonic modulators.

Therefore, by default, the dominant modulation methods for SLM's today, employed in image projection and display, telecommunications, and read-write arrays for optical media, are MEMS-type modulators or LCoS (liquid crystal on silicon), where the modulation element lies parallel, not perpendicular, to the plane of the device. In these systems, there is no means to couple light that is transmitted parallel to the plane of the device, only a means to reflect light out of the plane (or transmit light through a transparent optical substrate, as in a LC SOG (system on glass) microdisplay comparable in size to an LCoS.

There are, in addition to MEMS and LCoS SLM's, MOSLMS (magneto-optic spatial light modulators) developed by both Inoue et al. and by Ellwood (inventor of the present disclosure) Inoue, U.S. Pat. No. 6,762,872; Ellwood US Publication No. 20050201654). But both of these types of MOSLM's have been restricted to utilizing either planar magneto-optic thickfilms or planar magneto-photonic periodic thinfilm stacks (1D photonic bandgap structures).

MO thickfilms, the highest quality of which include BIG films (bismuth -substituted YIG, yittrium iron garnet) are currently fabricated by liquid phase epitaxy (LPE) and commercially available from such companies as FDK or Integrated Photonics.

But these highest quality MO films, since LPE cannot make thinfilms, cannot be used as photonic bandgap structures in this configuration, being, by definition, too thick to realize the lambda/4 thicknesses used for most MO layers.

However, while MO thinfilms have been fabricated by pulse laser deposition or RF magnetron sputtering, to the thicknesses required for 1D periodic PBG thinfilm stacks, the quality of these films and the orientation of the domain magnetization is 90 degrees opposite what is desirable for efficient structuring of an in-line MO modulator.

In addition, an entire wafer is used to fabricate continuous films in stacks of several to many tens of layers, which introduces many opportunities for defects in the films. And if there are other structures (field-generation structures, addressing, potential logic) to be integrated and deposited, this introduces further complications and raises the potential defect rate.

What is needed to solve both limitations, in both achieving 3D integration for PIC's and in removing the limitations on modulation technology available for SLM's, is a method of converting signal transmitted and modulated in-plane, from regular and irregular arrays of planar photonic devices, such as planar modulators, to out-of-plane. Such a solution will both enable best-in-breed modulation technology (cheaper, faster, and more environmentally stable than MEMS or LC) for use in SLM's as well as provide a pathway to 3D VLSI for photonics.

What is needed is a system and method for efficient signal processing and switching with a 3D or multi-layer device and between layers of such devices and into and out of the backplane, fore-plane, and sides of such devices, especially for the efficient, integrated and high-density integration of photonic signals and, including pixel signals and data signals, for computation or telecom signal processing or image display and pixel signal processing, and thereby effectively enabling the use of planar photonic and opto-electronic devices for functions such as display and spatial light modulation for which they will have been impractical or impossible to use before, and also thereby enabling such device types as “quasi-transmissive” and “transflective” displays and SLM's'; and in general supporting the greater integration, lower cost, and efficiency of heterogeneous devices, photonic integrated circuits, and hybrid devices and systems of all kinds for data signal processes in all categories known to the art.

What is needed is a system and method for improving VLSI of photonic components such as by improved volumetric packing density that preserves and/or enhances photonic operations and functions.

### BRIEF SUMMARY OF THE INVENTION

Disclosed is a system and method for improving VLSI of photonic components such as by improved volumetric packing density that preserves and/or enhances photonic operations and functions. The following summary of the invention is provided to facilitate an understanding of some of the technical features related to improved VLSI for photonic components, and is not intended to be a full description of the present invention. A full appreciation of the various aspects of the invention can be gained by taking the entire specification, claims, drawings, and abstract as a whole. The present invention is applicable to other functional components in addition to photonic encoders, SLMs, and other photonic processors, sensors, switchers, and distribution structures.

A new class of monolithic, “channel-coupled” or optically-channelized structures (including “optically-channelized spacer-controllers”) are proposed. These structures are more efficient than current state-of-the-art at receiving signals bounced from planar photonic bandgap reflection surfaces and point-defect photonic bandgap bends. These structures allow for a 3D coupling means to controllably couple planar signals from planar photonic elements into free-space or into other channelized structures. This scheme of optically-channelized photonics wafer(s) and optically-channelized spacer-controllers, bonded or fabricated or joined together in sequence and potentially repeated successively with many layers, realizes a multilayer 3D PIC architecture, with SLM free-space output and input coupling enabled at either topmost or bottommost layers. Display pixel signal processing, photonic telecom information signals, and photonic integrated circuit general computational data processing is significantly enabled.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates an imaging architecture that may be used to implement embodiments of the present invention; and

FIG. 2 illustrates a side sectional view of a multi-tiered photonic structure.

### DETAILED DESCRIPTION OF THE INVENTION

Embodiments of the present invention provide a system and method for improving VLSI of photonic components such as by improved volumetric packing density that preserves and/or enhances photonic operations and functions. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. Thus, for example, a size of a non-spherical object can refer to a diameter of a corresponding spherical object that exhibits light scattering or other properties that are substantially the same as those of the non-spherical object. Alternatively, or in conjunction, a size of a non-spherical object can refer to an average of various orthogonal dimensions of the object. Thus, for example, a size of an object that is a spheroidal can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

As used herein, the term “signal” refers to an output from a signal generator, such as a display image primitive precursor, that conveys information about the status of the signal generator at the time that the signal was generated. In an imaging system, each signal is a part of the display image primitive that, when perceived by a human visual system under intended conditions, produces an image or image portion. In this sense, a signal is a codified message, that is, the sequence of states of the display image primitive precursor in a communication channel that encodes a message. A collection of synchronized signals from a set of display image primitive precursors may define a frame (or a portion of a frame) of an image. Each signal may have a characteristic (color, frequency, amplitude, timing, but not handedness) that may be combined with one or more characteristics from one or more other signals.

As used herein, the term “human visual system” (HVS) refers to biological and psychological processes attendant with perception and visualization of an image from a plurality of discrete display image primitives, either direct view or projected. As such, the HVS implicates the human eye, optic nerve, and human brain in receiving a composite of propagating display image primitives and formulating a concept of an image based on those primitives that are received and processed. The HVS is not precisely the same for everyone, but there are general similarities for significant percentages of the population.

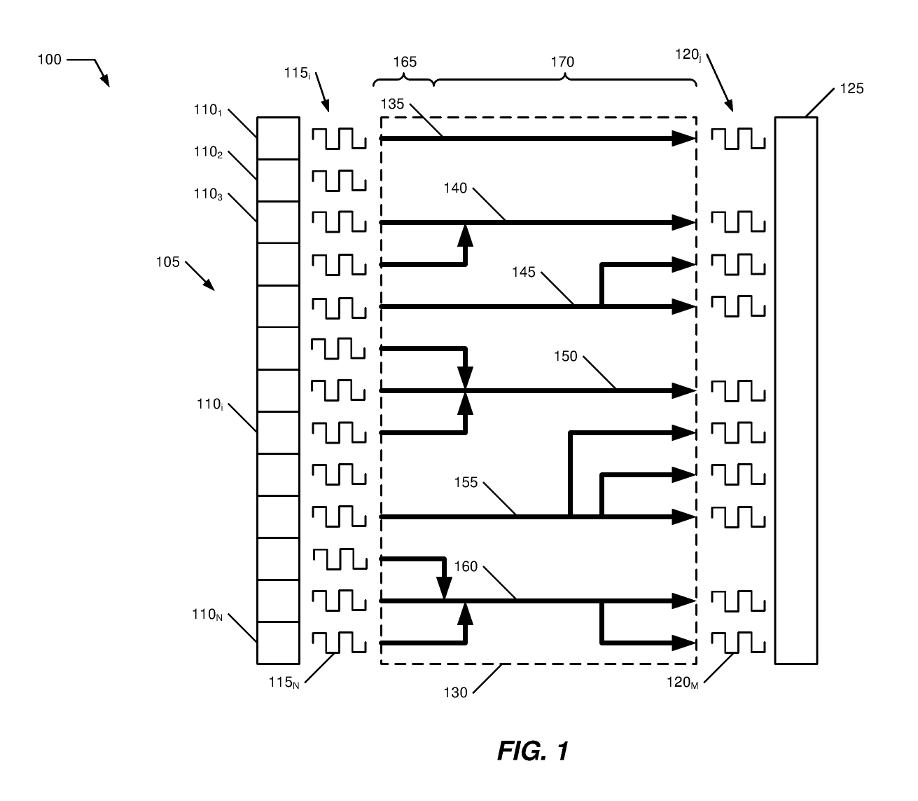

FIG. 1 illustrates an imaging architecture 100 that may be used to implement embodiments of the present invention. Some embodiments of the present invention contemplate that formation of a human perceptible image using a human visual system (HVS)—from a large set of signal generating structures includes architecture 100. Architecture 100 includes: an image engine 105 that includes a plurality of display image primitive precursors (DIPPs) 110ᵢ, i=1 to N (N may be any whole number from 1 to tens, to hundreds, to thousands, of DIPPs). Each DIPP 110i is appropriately operated and modulated to generate a plurality of image constituent signals 115ᵢ, i=1 to N (an individual image constituent signal 115ᵢ from each DIPP 110ᵢ). These image constituent signals 115ᵢ are processed to form a plurality of display image primitives (DIPs) 120ⱼ, j=1 to M, M a whole number less than, equal to, or greater than N. An aggregation/collection of DIPs 120ⱼ (such as 1 or more image constituent signals 115ᵢ occupying the same space and cross-sectional area) that will form a display image 125 (or series of display images for animation/motion effects for example) when perceived by the HVS. The HVS reconstructs display image 125 from DIPs 120ⱼ when presented in a suitable format, such as in an array on a display or a projected image on a screen, wall, or other surface. This is familiar phenomenon of the HVS perceiving an image from an array of differently colored or grey-scales shadings of small shapes (such as “dots”) that are sufficiently small in relation to the distance to the viewer (and HVS). A display image primitive precursor 110ᵢ will thus correspond to a structure that is commonly referred to as a pixel when referencing a device producing an image constituent signal from a non-composite color system and will thus correspond to a structure that is commonly referred to as a sub-pixel when referencing a device producing an image constituent signal from a composite color system. Many familiar systems employ composite color systems such as RGB image constituent signals, one image constituent signal from each RGB element (e.g., an LCD cell or the like). Unfortunately, the term pixel and sub-pixel are used in an imaging system to refer to many different concepts—such as a hardware LCD cell (a sub-pixel), the light emitted from the cell (a sub-pixel), and the signal as it is perceived by the HVS (typically such sub-pixels have been blended together and are configured to be imperceptible to the user under a set of conditions intended for viewing). Architecture 100 distinguishes between these various “pixels or sub-pixels” and therefore a different terminology is adopted to refer to these different constituent elements.

Architecture 100 may include a hybrid structure in which image engine 105 includes different technologies for one or more subsets of DIPPs 110. That is, a first subset of DIPPs may use a first color technology, e.g., a composite color technology, to produce a first subset of image constituent signals and a second subset of DIPPs may use a second color technology, different from the first color technology, e.g., a different composite color technology or a non-composite color technology) to produce a second subset of image constituent signals. This allows use of a combination of various technologies to produce a set of display image primitives, and display image 125, that can be superior than when it is produced from any single technology.

Architecture 100 further includes a signal processing matrix 130 that accepts image constituent signals 115ᵢ as an input and produces display image primitives 120ⱼ at an output. There are many possible arrangements of matrix 130 (some embodiments may include single dimensional arrays) depending upon fit and purpose of any particular implementation of an embodiment of the present invention. Generally, matrix 130 includes a plurality of signal channels, for example channel 135—channel 160. There are many different possible arrangements for each channel of matrix 130. Each channel is sufficiently isolated from other channels, such as optical isolation that arises from discrete fiber optic channels, so signals in one channel do not interfere with other signals beyond a crosstalk threshold for the implementation/embodiment. Each channel includes one or more inputs and one or more outputs. Each input receives an image constituent signal 115 from DIPP 110. Each output produces a display image primitive 120. From input to output, each channel directs pure signal information, and that pure signal information at any point in a channel may include an original image constituent signal 115, a disaggregation of a set of one or more processed original image constituent signals, and/or an aggregation of a set of one or more processed original image constituent signals, each “processing” may have included one or more aggregations or disaggregations of one or more signals.

In this context, aggregation refers to a combining signals from an S_{A} number, S_{A}>1, of channels (these aggregated signals themselves may be original image constituent signals, processed signals, or a combination) into a T_{A} number (1≦T_{A}<S_{A}) of channels and disaggregation refers to a division of signals from an S_{D} number, S_{D}≧1, of channels (which themselves may be original image constituent signals, processed signals, or a combination) into a T_{D} number (S_{D}<T_{D}) of channels. S_{A} may exceed N, such as due to an earlier disaggregation without any aggregation and S_{D} may exceed M due a subsequent aggregation. Some embodiments have S_{A}=2, S_{D}=1 and T_{D}=2. However, architecture 100 allows many signals to be aggregated which can produce a sufficiently strong signal that it may be disaggregated into many channels, each of sufficient strength for use in the implementation. Aggregation of signals follows from aggregation (e.g., joining, merging, combining, or the like) of channels or other arrangement of adjacent channels to permit joining, merging, combining or the like of signals propagated by those adjacent channels and disaggregation of signals follows from disaggregation (e.g., splitting, separating, dividing, or the like) of a channel or other channel arrangement to permit splitting, separating, dividing or the like of signals propagated by that channel. In some embodiments, there may be particular structures or element of a channel to aggregate two or more signals in multiple channels (or disaggregate a signal in a channel into multiple signals in multiple channels) while preserving the signal status of the content propagating through matrix 130.

There are a number of representative channels depicted in FIG. 1. Channel 135 illustrates a channel having a single input and a single input. Channel 135 receives a single original image constituent signal 115ₖ and produces a single display image primitive 120ₖ. This is not to say that channel 135 may not perform any processing. For example, the processing may include a transformation of physical characteristics. The physical size dimensions of input of channel 135 is designed to match/complement an active area of its corresponding/associated DIPP 110 that produces image constituent signal 115k. The physical size of the output is not required to match the physical size dimensions of the input—that is, the output may be relatively tapered or expanded, or a circular perimeter input may become a rectilinear perimeter output. Other transformations include repositioning of the signal—while image constituent signal 1151 may start in a vicinity of image constituent signal 115₂, display image primitive 1201 produced by channel 135 may be positioned next to a display image primitive 120ₓ produced from a previously “remote” image constituent signal 115ₓ. This allows a great flexibility in interleaving signals/primitives separated from the technologies used in their production. This possibility for individual, or collective, physical transformation is an option for each channel of matrix 130.

Channel 140 illustrates a channel having a pair of inputs and a single output (aggregates the pair of inputs). Channel 140 receives two original image constituent signals, signal 115₃ and signal 115₄ for example, and produces a single display image primitive 120₂, for example. Channel 140 allows two amplitudes to be added so that primitive 120₂ has a greater amplitude than either constituent signal. Channel 140 also allows for an improved timing by interleaving/multiplexing constituent signals; each constituent signal may operate at 30 Hz but the resulting primitive may be operated at 60 Hz, for example.

Channel 145 illustrates a channel having a single input and a pair of outputs (disaggregates the input). Channel 140 receives a single original image constituent signal, signal 115₅, for example, and produces a pair of display image primitives—primitive 120₃ and primitive 120₄. Channel 145 allows a single signal to be reproduced, such as split into two parallel channels having many of the characteristics of the disaggregated signal, except perhaps amplitude. When amplitude is not as desired, as noted above, amplitude may be increased by aggregation and then the disaggregation can result in sufficiently strong signals as demonstrated in others of the representative channels depicted in FIG. 1.

Channel 150 illustrates a channel having three inputs and a single output. Channel 150 is included to emphasize that virtually any number of independent inputs may be aggregated into a processed signal in a single channel for production of a single primitive 120₅, for example.

Channel 155 illustrates a channel having a single input and three outputs. Channel 150 is included to emphasize that a single channel (and the signal therein) may be disaggregated into virtually any number of independent, but related, outputs and primitives, respectively. Channel 155 is different from channel 145 in another respect—namely the amplitude of primitives 120 produced from the outputs. In channel 145, each amplitude may be split into equal amplitudes (though some disaggregating structures may allow for variable amplitude split). In channel 155, primitive 120₆ may not equal the amplitude of primitive 120₇ and 120₈ (for example, primitive 120₆ may have an amplitude about twice that of each of primitive 120₇ and primitive 120₈ because all signals are not required to be disaggregated at the same node). The first division may result in one-half the signal producing primitive 120₆ and the resulting one-half signal further divided in half for each of primitive 120₇ and primitive 120₈.

Channel 160 illustrates a channel that includes both aggregation of a trio of inputs and disaggregation into a pair of outputs. Channel 160 is included to emphasize that a single channel may include both aggregation of signals and disaggregation of signal. A channel may thus have multiple regions of aggregations and multiple regions of disaggregation as necessary or desirable.

Matrix 130 is thus a signal processor by virtue of the physical and signal characteristic manipulations of processing stage 170 including aggregations and disaggregations.

In some embodiments, matrix 130 may be produced by a precise weaving process of physical structures defining the channels, such as a Jacquard weaving processes for a set of optical fibers that collectively define many thousands to millions of channels.

Broadly, embodiments of the present invention may include an image generation stage (for example, image engine 105) coupled to a primitive generating system (for example, matrix 130). The image generation stage includes a number N of display image primitive precursors 110. Each of the display image primitive precursors 110ᵢ generate a corresponding image constituent signal 115ᵢ. These image constituent signals 115ᵢ are input into the primitive generating system. The primitive generating system includes an input stage 165 having M number of input channels (M may equal N but is not required to match—in FIG. 1 for example some signals are not input into matrix 130). An input of an input channel receives an image constituent signal 115ₓ from a single display image primitive precursor 110ₓ. In FIG. 1, each input channel has an input and an output, each input channel directing its single original image constituent signal from its input to its output, there being M number of inputs and M number of outputs of input stage 165. The primitive generating system also includes a distribution stage 170 having P number of distribution channels, each distribution channel including an input and an output. Generally M=N and P can vary depending upon the implementation. For some embodiments, P is less than N, for example, P=N/2. In those embodiments, each input of a distribution channel is coupled to a unique pair of outputs from the input channels. For some embodiments, P is greater than N, for example P=N*2. In those embodiments, each output of an input channel is coupled to a unique pair of inputs of the distribution channels. Thus the primitive generating system scales the image constituent signals from the display image primitive precursors—in some cases multiple image constituent signals are combined, as signals, in the distribution channels and other times a single image constituent signal is divided and presented into multiple distribution channels. There are many possible variations of matrix 130, input stage 165, and distribution stage 170.

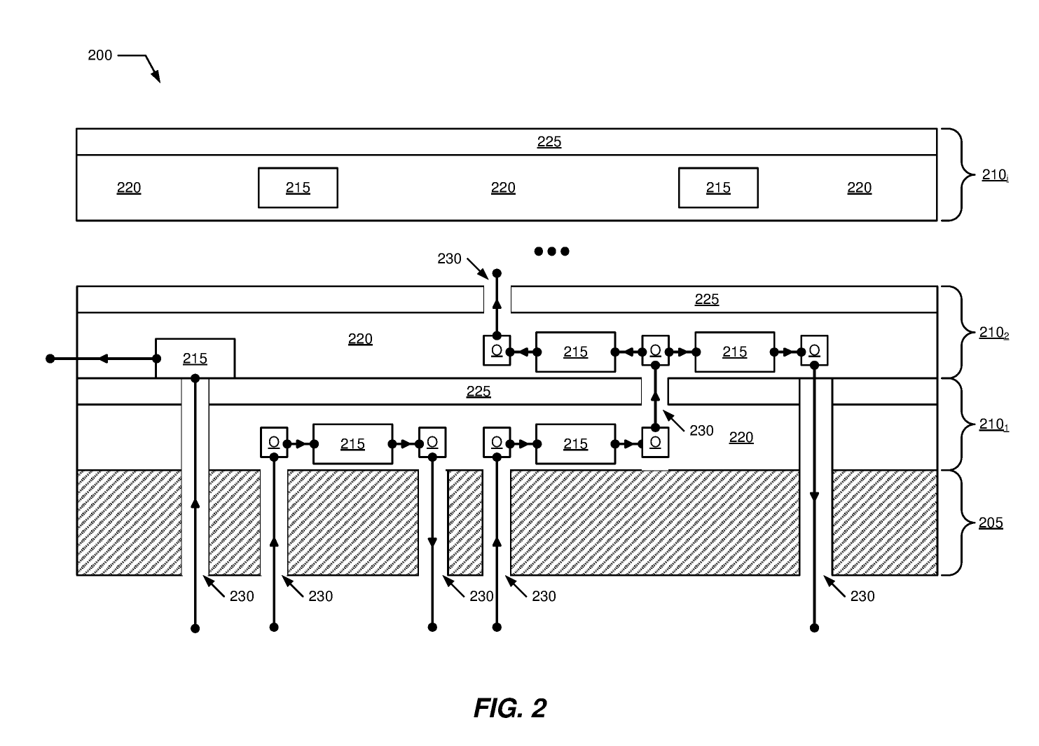

FIG. 2 illustrates a side sectional view of a multi-tiered photonic structure 200. Structure 200 may be used to implement the imaging architecture of FIG. 1. Structure 200 may be used in other embodiments in addition to the imaging architecture, including sensing, routing, modulating, emitting, transmitting, processing, switching, amplifying, encoding, generating, detecting, and manipulating photonic information, and other data used with, derived from, or cooperative with photonic information, photonic signals, photons, and the like. As was true for integrated circuits, some implementations were limited by a physical planar area. Improving a “packing” density photonic structures offers many advantages. Embodiments of structure 200 may provide improved density, among other advantages.

Structure 200 includes a substrate 205, and a number N, N≧1, tiers 210. As illustrated, structure 200 includes i number of tiers, i=1 to 5, or more. Each tier 210ₓ includes a set of photonic elements, such as photonic functional elements 215, including for example, a wave property modulation device (e.g., Faraday Effect device or the like). There are many possible specific photonic functional elements 215, active or passive.

Other photonic elements may include path optics O which direct and route photons both intra-tier and inter-tier. Path optics may include special structures or materials, including dielectric or other material mirror, prism, point defector other light-path redirecting structure.

A spacer material 220 surrounds the set of photonic elements on each tier 210ₓ. The spacer material may include, for example, a low index of refraction material such as aerogel. A superstrate 225 of each particular tier 210ₓ separates the particular tier 210ₓ from an adjacent tier 210ₓ₊₁.

Some embodiments may include a set of independent multi-tier planar stacks, each tier including its set of photonic elements. As illustrated in FIG. 2, however, one or more of substrate 205 and tiers 210ₓ each include one or more optical vias 230. Each optical via 230 provides a transmission path for photons through the one or more of substrate 205 and tiers 210ₓ. As illustrated, proper orientation of the set of optical vias 230 enables multi-tier cooperation of the photonic elements. Photonic elements of one tier 210ⱼ may include a first set of functions operating on an incoming collection of photons and produce a first output set of processed photons. An optical via 230 allows the first output set of processed photons to be communicated to another tier 210ₖ. Photonic elements of tier 210ₖ may include a second set of functions (which may or not include, or partially include, some of the function of the first set of function) operating on the first output set of processed photons to produce a second output set of processed photons. The second output set of processed photons may be directed to another part of structure 200 for further processing (which may be communicated to another tier or to another part of the same tier) or may be exited from structure 200.

Some embodiments may additionally include non-photonic functional elements on one or more the tiers 210ₓ. These non-photonic functional elements may support the photonic functional elements and they may be passive or active. Elements of structure 200, such as powered elements, may receive power using wireless transmission or wired transmission such as through conventional vias or conductors disposed in one or more tiers or in the substrate. U.S. Patent Application No. 62/181,143 filed 17 Jun. 2015 and U.S. Patent Application No. 62/234,942 filed 30 Sep. 2015 include a discussion of wireless power transmission and wireless addressing that may be used for wireless implementations; the entireties of the contents of both of these patent applications is hereby expressly incorporated by reference, for all purposes.

A 3D channel-coupled photonics device structure and system is proposed, comprised of the following elements:

1) An efficient photonic light-path deflection or bending means, which is preferably a photonic bandgap or periodic dielectric (grating) structure fabricated in or on a wedge of material wedge at approximately 45 degrees to the plane of the planar device surface to receive either an input optical beam or signal from the z-axis (normal to the plane) to be coupled in-plane, or a beam or signal from the x-y plane to be coupled to the z-axis (normal to the plane). The preferred photonic bandgap and which may be 1D, 2D or 3D periodic structure, with the 3D periodic structures being the most efficient in bandwidth-selectively reflecting an optical beam or signal. The 45 deflector may be a simple individual “pane”,” or it may be a facet in a partial, roughly circular array.

Various fabrication methods known to the art may be employed to fabricate a 1D grating structure, but a preferable method is to employ an imprint lithography method, such as is available commercially from Molecular Imprints or HP. In some cases, a master “die” may be preferably fabricated by means of FIB (focused ion beam).

Arrays of such efficient beam deflection means maybe fabricated to realize a “pure” spatial light modulator array, or more complicated photonics circuit designs may employ these x-y-x deflection means at selected junction points, where a signal either is required to couple into the x-y device plane from outside the plane, or from the x-y device plane to the z axis, either in freespace.

Another preferred method of efficient optical beam or signal deflection means is a photonic bandgap point defect fabricated in a dielectric material, which forces tunneling of the photons from one point to another, and upon reaching the point defect, effecting a nearly 90-degree bend as the photons travel to the next defect (John D. Joannopoulos, MIT; incorporated Ab-Initio Research Group website http://ab-initio.mit.edu/photons/bends.html). By this method, “buried” channels may be fabricated by careful design of defect spacing, index and size, employing fabrication methods known to the art [citation—ion implantation, etc.]. Coupling in- and out-of-plane is accomplished by locating a coupling point defect above an interior (bend point) defect, with a third point defect lying substantially in the same x-y plane as bend-defect.

A final efficient method of efficient optical beam or signal deflection means is implemented by a normalized set of ring resonators, comprising of at least one z-axis ring resonator fabricated and vertically aligned alongside a z-axis input channel, with at least one x-y plane resonator fabricated and aligned at right angles to at least one of the z-axis ring resonators, such that the z-axis and x-plane resonators resonantly couple with each other, thus effecting efficient beam or signal transfer in or out-of-plane, whether originated from in-plane or out-of-plane.

An example of a “non-efficient” un-optimized (broadband efficient, not tuned to band) beam deflection means include metalized or polished flat-mirrors fabricated at 45 degrees to the x-y plane, as proposed by the inventor of the present disclosure in US Publication No. 20050201654 for deflecting beams from planar magneto-optic modulators, and as demonstrated and fabricated by Dr. Miguel Levy at the Michigan Technical University, under a program funded by the inventor of the present disclosure.

An important variant of the efficient optical signal or beam deflection means is one in there are both input and output beams with respect to an individual modulator. This is an important requirement for SLM' s.

Thus, an input beam on the z-axis, originating outside the x-y device plane, is coupled into the planar modulator by a first efficient optical signal or beam deflection means, which passes the signal to the modulator. To the extent that the signal is to be passed from the modulator to the next functional stage, a beam is passed to a second efficient optical signal or beam deflection means, which couples the light out of the plane.

Two variants of this input-output efficient optical signal or beam deflection setup exist, one in which the input signal and the output signal originate from the same side of the x-y device plane (an overall “reflective” SLM configuration, in the case of an SLM embodiment of the present invention), and one in which the input signal originates from one side of the x-y device plane and the output signal is passed to the other side of the x-y device plane.

The second case may be characterized, in an SLM embodiment of the present disclosure, a “transmissive” SLM configuration.

In a 3D PIC configuration, which multiple x-y device layers are monolithically integrated and separated by channelized spacers, such an x-y device configuration allows signal passed from a bottom x-y device layer to be process by planar photonics (modulators, etc.) in the present layer, and then passed to either an x-y device layer above the present layer, or into freespace, as SLM or quasi-SLM output.

Whether a “transmissive” SLM configuration, or a 3D PIC “pass-through” configuration, the substrate of the x-y device plane in such as case must be channelized, i.e., structured in such a way to allow input of signal “through” the substrate to be coupled into efficient optical signal or beam deflection means, which then pass those signals to planar photonics modulators or other elements. The characterization and methods of structuring and fabrication of such channelized wafers is provided for below in the present disclosure.

There will typically be differences between input and output deflectors, as expanded in a subsequent section below. But briefly, input deflector dimensions will typically be greater (wider, in the case of a flat-angled grating), to increase the ease of coupling from an input channel.

2) A second essential element of the 3D channel-coupled photonics device and system consists of optically channelized spacer-controllers, which are beam-guiding and sizing means, held fixed adjacent or bonded to at least one x-y photonic device plane, which implements a monolithic combined structure, with the benefits attendant to that in eliminating dust and contamination to the x-y array, while efficiently segregating in- and out-coupled beams on the z-axis from each other and optically controlling their paths and beam-diameters.

In the case of a regular array of z-axis beams output from an array of planar modulators, which pass optical pixel signals or beams (as modulated by each modulator individually) to the efficient optical signal or beam deflection means assigned to each modulator, a regular-array SLM is intended. In this case, regularly spaced and in most cases identically-dimensioned optical channel structures are used to guide and size the x-axis, out and in-coupled optical signals or beams.

In the case of a more complex x-y photonic logic design, whether x-axis out-couples signals are intended to be input to another x-y-device planer layer, or simply out-coupled into freespace to be received by other discrete devices, the optical channel structures to guide and size the optical signal or beams may be irregularly separated from each other in the x-y plane of the channelized spacer-controller structure.

In the case of a “transmissive SLM” or 3D PIC “pass-through” configuration, in contrast to a “reflective” SLM configuration, channels are in most cases normal to the plane of the x-y plane device, that is, perpendicular to the device plane and parallel to each other.

In the case of a “reflective SLM” configuration, however, input optical signal or beam will either by necessity (in the bulk illumination of an entire SLM for image display purposes) or most commonly otherwise, require the input and output channels to diverge in axes or pathways from each other. (A special case embodiment which does not require optical I/O axis separation is disclosed elsewhere below).

In most SLM's for display application especially, input illumination is directed at the SLM array from one angle, and is bounced off of the typically reflective or interference grating angle at another angle. This segregates the optical paths and reduces interference or cross-talk.

The solid-state method disclosed herein provides for input and output channels in a special variant of channelized spacer-controller shaped, in vertical cross section, roughly in the form of an irregular pentagon, in which the solid-state optical input channels are at an equal and opposite angle to the optical output channels.

With respect to the orientation of the planar modulators on the x-y device layer, if the modulators can be arbitrarily taken to lie parallel to the x-axis, then the planes formed by the input and output channels are formed by the y-z axes and thus a projection of the input and output channels onto the x-y plane “below” will form a line at right angles to the x-axis of the modulators.

If the z-axis is visualized as “tree-trunks” arising from the x-y plane, and we are facing the z-y plane parallel to the tree-trunks, then input channels may be seen as being all the branches on one side of the trees, with the output channels being all the branches on the opposite side of the trees.

Noting that input channels are aligned to one “end” of the compound device formed by a set of efficient optical signal/beam deflection means framing a modulator (or modulator plus other devices), with output channels aligned to the opposite “end,” the planes formed by the input and output channels may be seen as alternating with each other.

The modulators then may be seen as lines on the x-y ground at right angles to the alternating planes formed by the alternating left-right branches of the z-axis tree-trunks.

Input and output channels in the channelized structure are thus interleaved.

In another embodiment, they may of course be aligned with the same axis as that of the modulators on the x-y plane, but the preferred embodiment allows for a greater degree of freedom on fabricating the input and output channels, including providing for a 3D-woven textile method (as disclosed in US Publication No. 20050201674) for fabricating and realizing the solid-state, optically-channelized spacer-controller.

If the far ends of the output channels and the ends of the input channels are terminated together to form two relatively smooth planes, we have the input surface optics for the spatial light modulator and the output surface, spatially separated from each other to allow for efficient operation.

The preferred methods for fabricating the channelized structures include the 3D textile-fabrication methods employing optical fibers as the optical guiding structures, as disclosed by the inventor of US Publication No. 20050201674.

In this method, individual fibers or groups of fibers in “cells” are held in place by structural fibers or filaments. The optical fibers, typically without the environmental cladding required for telecommunications and stripped down only to operative optical layers, form the channels, with structural x-y filaments or fibers (and possibly structural filaments or fibers lying parallel to the optical fibers or diagonally within the overall textile structure).

Depending on the dimensions of the optical fibers, the x-y structural textiles and portion of the overall structure may only be implemented for a portion of the length of the optical fiber, such that the optical fiber ends are tapered to a tightly-packed bunch, with a diameter less than the textile-structural section which secures the fibers. A banding element around the fiber-ends may be employed, with or without a bonding material (infused and cured sol) or epoxy or thermal fusing), to maintain the fiber ends in close position.

The fiber-ends thus grouped may optionally be thermally process and drawn together to form a taper, as is known to the art of fiber-optic faceplates.

The methods of the referenced disclosure may be employed to realize an integrally-fabricated optical part, which is not a solely “textile-structured” part, but which realizes an optical part employing textile-structured preforms which are then deformed, typically by a combination of thermal processing and stretching and compression (stretching, as in fiber-drawing, which is but one example of feature-reduction by deformation) to realize channelized structures with greater design latitude, optimized materials composition, and feature-size control.

While many versions of the optically channelized spacer-controller will either require or will benefit from this close-packing, such as SLM's, such spacing tolerances may be relaxed by an additional novel proposal of the present disclosure, specifically, by increasing or modifying the dimensions or orientation of the modulators in the SLM modulator array. Thus, if optical fiber dimensions require it, or a textile-structured space-controllers are preferred for the cost and other efficiencies of fabrication they confer, then the footprint of each set of modulator-deflectors can be increased to better match the dimensions of the fiber array.

One simple embodiment of the present disclosure in which this novel optimization herein proposed can be undertaken, which may or may not be used planar modulators and deflectors (i.e., adaptable to vertical LC, OLED, or VCSELs, etc.) which is not otherwise possible in direct-view micro-display SLM's such as LCD for mobile devices, or DMD's or LCoS chips for image projection, leads to increased, rather than reduced, fill-factor for LC or OLED cells.

A very basic channelized spacer-controller, integrated with a micro-display, formed by textile-type fabrication of optical fibers, may be married integrally with a specially-optimized LC or OLED or hybrid array or modulator-deflector pass-through (“transmissive”) array. The specially optimized pixel-modulation array is not optimized for the conventional minimal fill-factor of un-mediated direct-view, but optimized for efficient coupling with the optical fiber dimensions.

This relaxation of fill-factor requirements has additional benefits, in that there is wafer real-estate made available for other functionality, including addressing logic, thermal dissipation structures, and other device functionality which is otherwise constrained by the dominating fill-factor minimization requirement. More efficient solutions for the other functions are thus enabled by the relaxation of fill-factor requirements for conventional direct-view “SLM” arrays.

Other preferred methods for fabricating and realizing optically channelized spacer-controllers including the commercially-available products from Collimated Holes, Inc., of California, USA. Collimated Holes manufactures solid conventional optical materials with regular arrays of capillary holes by combination of glass-drawing and etching.

Another preferred method for formation of optically channelized spacer-controllers is found by employment of aerogels and aerogel composites.

Aerogels have been employed for the superior electrical insulation properties of some aerogels in semiconductor electronics (commercial coatings from Cabot Corporation and others).

The benefit of aerogels for the present disclosure is the combination of structural strength in compression and tailored properties currently available for aerogels, including those made possible by recent efforts to infuse nano-particles in aerogel matrixes.

Composites of different aerogels, which include silica aerogels and CNT aerogels (carbon nanotubes), can realize different thermal, electrical, and magnetic functionality, including opposing and conducting properties and thus conducting or insulating channels which can work cooperatively with the x-y device layers.

Optical channels in aerogels can be realized by alternating aerogels and aerogel composites of differing indices of refraction, or etching aerogels to implement periodic voids and thus realize guiding by bandgap or modified total index of refraction (aerogel photonic crystals). Classic silica aerogel possess the closest index of refraction to air, so “pillars” of aerogel etched out of a solid aerogel layer, surrounded by a higher-index material or materials deposited or grown afterwards (including another aerogel), may realize significantly superior, structurally strong optically channelized spacer-controllers.

Optical fiber may be used in conjunction with aerogels to form strong composites. Companies such as Aspen Aerogels, of Colorado, USA, have demonstrated novel commercial composites of aerogels and other fibers which eliminate the fracturability problem long associated with aerogels. In addition, a layer of aerogel may be deposited on the x-y device layer and planarized, with the array of fiber (textile-structured array, fused array, or consolidated optical part by means of textile-structured and processed preforms) bonded to the aerogel, or the aerogel fabricated with the planar device and fiber array in-situ.

Aerogels possess further benefits for planar photonics devices and passive photonic bandgap elements, which are formed in part by gratings structures. The nearly-as-low-as-air index of refraction of aerogel fabricated as a layer coating and insulating the gratings structures preserves close to the same efficiency of the devices as compared to air as a dielectric, while providing the structural and other functional benefits previously described.

Optical nano-fibers, which have demonstrated evanescent coupling, may be employed in a low-index aerogel matrix as an alternative hybrid optical fiber-aerogel structure.

A key functional feature of the optically-channelized spacer-controller is to provide for efficient coupling between the efficient planar deflectors and the channels (input or output).

In the preferred embodiment of this element, the ratio of the size of the input channel end that faces the input deflector (one or more panels, including up to a near (rough) circle, is less than 1:1. The input deflector dimensions should be larger than the exit port of the input channel, to enable more efficient (lower-loss) optical coupling.

Inversely, the output deflector, which receives the optical signal or beam from the planar modulator, should be smaller than the dimensions of the launch end of the output channel.

Air-filled channels or aerogel-filled channels that are in contact with aerogel-buried deflectors, with very low index, are particularly advantageous. Thus, hollow-core photonic crystal fiber is particularly useful, or aerogel-core fiber or channelized aerogel or the “capillary hole” solid optical parts from Collimated Holes.

The continued reduction in feature size of planar elements, including modulators, thus works cooperatively with this optimization criteria for ratios between deflector dimensions and input and output channels. Best-in-breed planar modulators are already fabricated in dimensions substantially less than the dimensions of most optical fibers, and input deflector gratings can thus easily be fabricated larger than the dimension of fiber ends.

The previously proposed novel composite optically-channelized spacer-controller, combining optical nanowires embedded in an aerogel matrix, provide an alternative efficient coupling paradigm, including by contacting nanowires directly to rib waveguides fabricated on the surface of the x-y device plane. Growing vertical filaments from x-y planar structures is another fabrication option within this paradigm.

An essential function performed by the channelized space-controller is to not only guide each optical signal or beam from the device of origin on the x-y device plane, but to provide for beam-sizing as well.

The dimension of the channelized structure itself, over the length of the structure, will alter the beam diameter. In SLM application, this decouples (as with the previous disclosure where dropping the fill-factor constraint optimizes other device functionality) modulator dimensions from final viewable pixel dimensions.

Expanding on this purpose, the channelized array in an SLM application may benefit from expanding overall, with the individual channels expanding in diameter. Pixel-scaling, by means of inter-fiber coupling as disclosed in the incorporated US '461 application, also by the inventor of the present disclosure, teaches a way of expanding pixel dimensions entirely by fiber-textile methods.

The 3D Textile Preform disclosure by the present inventor, previously referenced, may be applied to realize channels of increasing diameter by the process of successive woven layers of same-index material of widening diameter that is consolidated during thermal-heating-deformation.

Fused fiber-optic tapers can scale pixels up to approximately a ratio of 5:1 or 1:5, but they suffer from expense of fabrication and from higher incidence of defects introduced in the fiber. It is less suitable for PIC applications in which digital optical signal is to be routed between x-y device layers, because the efficiency and guiding properties of the fiber may be compromised.

In 3D PIC applications, scaling up to a viewable pixel dimension is not required; on the contrary, typically scaling-back down to PIC dimensions is what is required, if a channel of larger aperture is employed to realize efficient out-coupling.

The same methods for pixel up-scaling may be employed to realize pixel down-scaling, with the exception that fiber-optic faceplate tapers are drawn down to a smaller facing fiber-end area and thus are less than suitable for PIC applications in a sandwich structure as proposed by the present disclosure, in which multiple x-y device layers of advantageously the same area are unified and integrated by means of optically channelized spacer-controllers.

It is evident that choice of channel dimensions vs. deflector dimensions both ensures efficient coupling and provides a means for altering beam dimensions.

However, additional beam shaping means may be necessary or desirable in some applications, which may be modifications of optical structures in the optically-channelized spacer-controller, optical structures on the surface of the x-y device layers, or both.

3) Additional Beam Shaping: for applications such as direct-view SLM's, such as a micro-display or in fact direct-view displays of any size, including up to and beyond wall-size, employing either the primary planar modulator paradigm of the present disclosure, or the ancillary application of elements of the present application to vertical modulators (an instance of which is disclosed above, to LCD, OLED, MO, etc.), beams will be desired to diverge dramatically from the final output surface of the optically channelized spacer-controller, to realize maximum viewing angle.

For this purpose, a diffusion material, preferably the non-periodic materials manufactured by Luminit, Inc. of California, USA provides efficient diffusion from a narrow-diameter source. A sheet of such material may be bonded, with or without transparent spacing layer such as an optical epoxy or aerogel, to the primary spacer, or the non-periodic diffusion structures may be fabricated on a layer of pre-form material, by embossing or other surface-texture transfer methods, to the primed layer.

Additional optics strategies may be employed, including those disclosed in US Publication No. 20090231358—the incorporated '461 application, by the inventor of the present disclosure, including all-fiber methods employing lateral-leaky-fiber. Fiber-ends may be themselves modified for increased dispersion as well, and are commercially available and know to the art.

Other image-display SLM applications, and applications of SLM”s to telecommunications OOO (all-optical) switching and read-write arrays for optical storage media, such as holographic storage discs, require beam shaping of the opposite type, including further focusing of beams, or at a minimum, zero-dispersion.

Gratings structures, including Fresnel-type gratings, fabricated on optical layers or coatings disposed on the faces of optically-channelized spacer-controllers; or lenslets fabricated on such materials or material sandwiches; or modified fiber-ends (including lenslets-on-fiber); and all-textile fiber-optic taper-down methods disclosed in the previously incorporated Application by the inventor of the present disclosure, or left-handed meta-material-based lenses structures with negative indices of refraction fabricated on layers bonded to the primary spacer; or hologram structures, similarly fabricated; any of these and other methods known to the art by be employed, individually or in combinations, to achieve further beam shaping and control from as the optical signal or beam exits the optically-channelized spacer-controller, whether for an SLM application or a 3D PIC embodiment requiring the same control or beam-size reduction as those SLM applications.

4) Channelized wafers.

To realize optical coupling from both sides of an x-y device layer, such as a chip or larger device, which is required for both “transmissive SLM's” and for multi-device layer 3D PIC's, channels must be fabricated not only in the active device layer where the photonics devices, such as planar modulators, are fabricated, but through the substrate as well.

Whether in a CMOS materials regime, a SOG materials regime, a photonics materials regime employing materials such as GGG for magneto-optic or magneto-photonics, or another other “pure” or hybrid platform, many if not most of the methods disclosed for fabricating the optically-channelized spacer-controller parts may be employed.

A composite wafer-type structure may be realized with zones and sectors, down to the element level, fusing materials of differing device regimes in a kind of t-pattern matrix. By this method as well, either holes or index-contrast solid-state guiding channels, or photonic bandgap or modified total index of refraction “holey” or layered dielectric coupling may be efficiently and flexibly implemented.

In more conventional fabrication system, fabrication of holes by methods for optical substrates, such as employed by Collimated Holes, or conventional deep-etching methods, including methods developed for fabrication of conductive vias, and other methods, known to the art may be employed to realize air holes, filled holes with step-index guiding, and the other types previously referenced herein and known to the art.

Except for cases in which a 3D PIC may be side-mounted, most 3D PIC embodiments will have a bottom substrate which does not require channelization. But any other device layers in the 3D PIC structure will require a least a thinned structural substrate which must be channelized. Aerogel again may be employed to provide structural reinforcement with superior device properties, reducing the thickness of the substrate retained for the conventional substrate required for device fabrication, and channelized by methods previously disclosed herein.

Film substrates, or woven substrates, or other composite and hybrid substrates may also be integrated by means of the method of systems of the present disclosure.

In applications where a 3D PIC or SLM or SLM/PIC device is side-mounted, both faces of the composite device may have a optically-channelized space-controller as the outer surface, integrated with an outer x-y device (chip or larger), with either free-space or fiber-device coupling or both to and from either face.

In many 3D PIC embodiments, for simplicity of fabrication and as a specific designs solution for a 3D architecture, only a few channels between layers may be required, and in this case the few channels become higher-density communication buses in a compact fiber-optic telecommunications-type network between layers.

Channelized wafers can also be employed for an alternative solution to a “reflective SLM,” realizing another unique embodiment.

In contrast to the more general cases for optically channelized spacer-controllers for SLM's, there is a special case where an SLM application may be implemented without using divergent axes or paths for the optical input and output to the SLM, in which the SLM application is realized by a 3D PIC-type device of the present disclosure, of at least two layers, at least one of which is a channelized pass-through chip/device/layer.

One x-y device layer contains the planar modulators, such as a Mach-Zehnder modulators, ring-resonator modulators, or magneto-optic or magneto-photonic modulators, or hybrid combinations of these or other modulators. Parallel input and output channels are structured in the channelized spacer element, with an input channel aligned to the input efficient optical signal or beam deflection means, and an output channel aligned to the output efficient optical signal or beam deflection means.

A second, facing x-y device layer (facing relatively “down” or “at” to the modulator layer) consists of sets of pixelized illumination elements, such as LEDs or VCSELs, aligned with the input channels, at the either of end of which is the input efficient optical signal or beam deflection means. These illumination elements or means are paired with a channel in the x-y device layer that permits the output optical signal or beam deflected by the efficient output deflection means of the x-y modulator array and passed to the output channel in the space aligned with the output deflection means.

A final channelized spacer-control layer is bonded or fabricated on or mechanically fixed and aligned to the “top” of the illuminator/pass-through x-y device layer, so that the output optical signal or beam that is passed-through is controlled and sized for the SLM application desired.

Thus, this is an example of SLM realized by optically channelized chip or wafer or device layer, without requiring the I/O path-separated channelized structures disclosed elsewhere herein.

In general, the proposed 3D PIC architecture is not limited to the particular embodiments or exemplary methods described.

Further, it is understand that the spirit and general principles of the disclosure have the combined effect of realizing a new class of practical 3D PIC devices that provide an alternative and complementary path to VLSI for PIC's and 3D integrated circuits in general. At the same time, the new systems and methods, device types and structures will provide a method by which SLM's may be realized using planar photonics modulators and planar photonics that in general have never before been possible for SLM's, but which are otherwise best-in-breed and superior to current vertical SLM's, such as LC, OLED and MEMS. The proposed new class of 3D PIC/SLM devices will deliver decisively superior products for telecommunications, computing, read-write arrays for optical storage media, and image display and projection, ranging from micro-displays to wall-size. Liberating planar photonics from two dimensions will deliver the greater speed, environmental robustness, ease and cost of fabrication, lower power consumption, lightness, and greater optical control to computing, data storage, telecommunications and image displays of virtually every type.

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. The apparatus substantially as disclosed herein.

2. The method substantially as disclosed herein.
